(19) United States
(12) Patent Application Publication
(10) Pub. No.: US 2010/0293605 A1
(43) Pub. Date: Nov. 18, 2010

(54) POSITIONAL PASSWORD CONFIRMATION

(75) Inventor: Giuseppe Longobardi, Naples (IT)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/466,073

(22) Filed: May 14, 2009

(51) Int. Cl. G06F 21/00

(52) U.S. Cl. 726/5

(57) ABSTRACT

Adding a layer of security to access login credentials increases security while preserving the efficiency of automatically providing locally stored website login credentials. This security layer can prevent an unauthorized user, who gains access to a login panel or launches a web browser, from retrieving and inappropriately using the stored login credentials. Functionality can be implemented to use positional security information to locally verify the authenticity of a user trying to access stored login credentials. The positional security information can restrict access to/use of the stored login credentials. This can help reduce the possibility of an unauthorized user accessing and using the locally stored website login credentials.

### BACKGROUND

Embodiments of the inventive subject matter generally relate to the field of computer security, and more particularly, to techniques for positional password confirmation.

Applications (e.g., web browsers) provide users with an option of storing their login credentials (e.g., username and password) to minimize time spent by a user in logging in, to add flexibility, and to improve the application's usability. The application may automatically enter in the user's login credentials whenever the application is launched or after the user types in a username.

### SUMMARY

Embodiments include a method comprising a device for presenting a positional security interface. The positional security interface indicates a plurality of selectable positions that govern automatic use of at least one locally stored login credential. An indication of at least a first of the plurality of selectable positions on the positional security interface is detected. It is determined whether the first of the plurality of selectable positions is associated with the at least one locally stored login credential. Automatic use of the locally stored login credential for accessing a corresponding resource is authorized, if it is determined that the first of the plurality of selectable positions is associated with the at least one locally stored login credential.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram illustrating operations for associating positional security information with login credentials.

FIG. 2 is an example conceptual diagram of protecting login credentials with positional security information.

FIG. 3 is a flow diagram illustrating example operations for configuring positional security to protect stored login information.

FIG. 4 is a flow diagram illustrating example operations for implementing positional security for local authentication.

FIG. 5 is an example computer system for configuring and implementing positional security to protect stored user credentials.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to implementation of positional security on web browsers, positional security may also be implemented on other applications (e.g., word processing applications, etc.). In some instances, well-known instruction instances, protocols, structures, and techniques have not been shown in detail in order not to obfuscate the description.

Adding a layer of security to access login credentials increases security while preserving the efficiency of automatically providing login credentials. The layer of security can be based on positional security information. The positional security information efficiently restricts access to the login credentials. Prompting users to enter positional security information before granting access to login credentials can help reduce the possibility of an unauthorized user accessing and using the locally stored login credentials. The positional security information can also be associated with additional security information (e.g., a user identification number, a nickname, etc.) to further reduce the possibility of illegal access of login credentials, thus minimizing unauthorized application access.

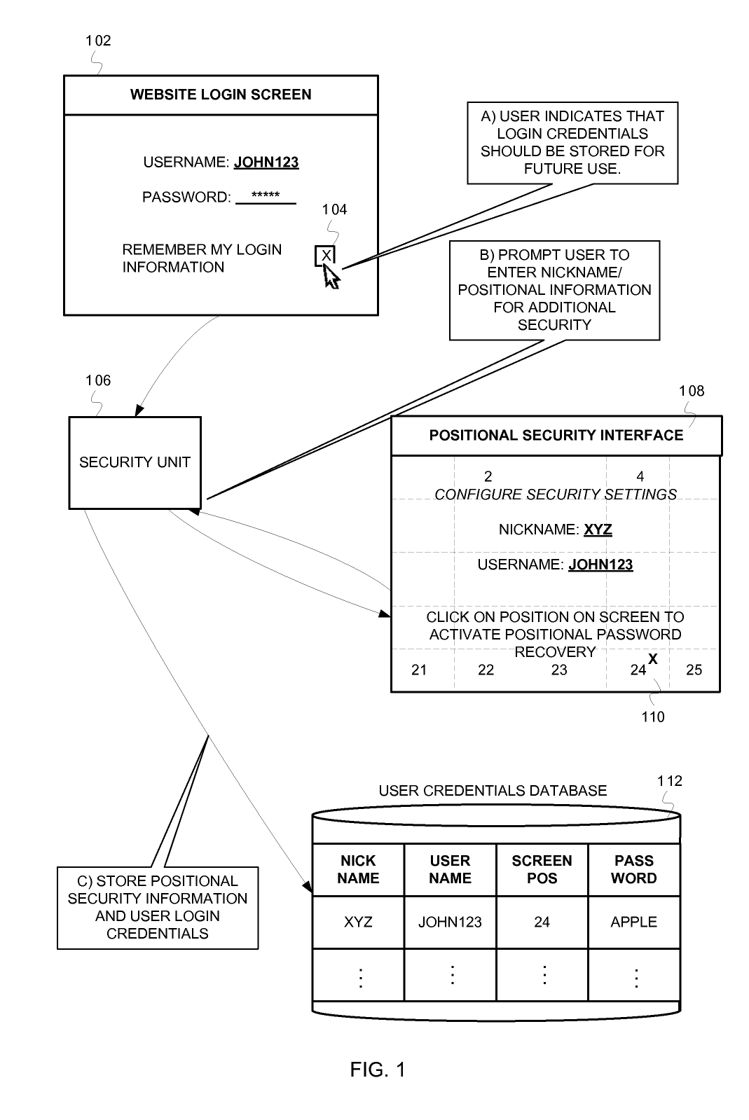

FIG. 1 is an example conceptual diagram illustrating operations for associating positional security information with login credentials. FIG. 1 depicts a website login screen 102, a positional security interface 108, a security unit 106, and a user credentials database 112.

When a user launches a browser instance and requests access to a website, the browser instance displays the website's login screen 102. The website's login screen 102 prompts the user to enter a username and a password (“login credentials”) to log into the website. The user also has an option of storing the entered login credentials for convenient access and future use. At stage A, the user marks a checkbox 104 indicating that the browser instance should store the entered login credentials for future use.

The security unit 106 detects that the browser instance is trying to store the entered user credentials. At stage B, the security unit 106 presents the positional security interface 108 and prompts the user to enter security information. As depicted on the positional security interface 108, the user is prompted to enter a nickname and click on a position on the interface 108 to configure positional security. The positional security interface 108 comprises a grid with 25 cells. Although depicted as 25 cells, the number of cells that comprise the grid on the positional security interface 108 is variable and may be configured by the user. Each cell is numbered row-wise. To configure positional security, the user clicks on any one of the 25 cells. The security unit 106 determines and stores an identifier (e.g., cell number) associated with the selected cell. In FIG. 1, the user clicks on cell 24 (110). Alternately, the cells may also be numbered column-wise or may be represented as a combination of a row number and a column number. Embodiments can use various techniques for triggering presentation of the positional security interface 108. For example, the browser instance may direct the security unit 106 to display the positional security interface 108 when users indicate that their login credentials should be stored.

At stage C, the security unit 106 stores the user's username and password along with the positional security information in the user credentials database 112. The security unit 106 may also store the user nickname in the user credentials database 112. The user credentials database 112 comprises stored login credentials required for website access (e.g., username and password) and security information (e.g., positional information, nickname, etc.) used to locally verify the authenticity of the user. The security unit 106 may store other security information, if entered, such as a user identification number, biometric data (e.g., fingerprints), etc. The user credentials database 112 may be encrypted to protect the stored credentials. The user credentials database 112 may be part of the browser cache memory or may be separate from the browser memory. The stored security information is used to verify a user, before the user's login credentials are retrieved and applied.

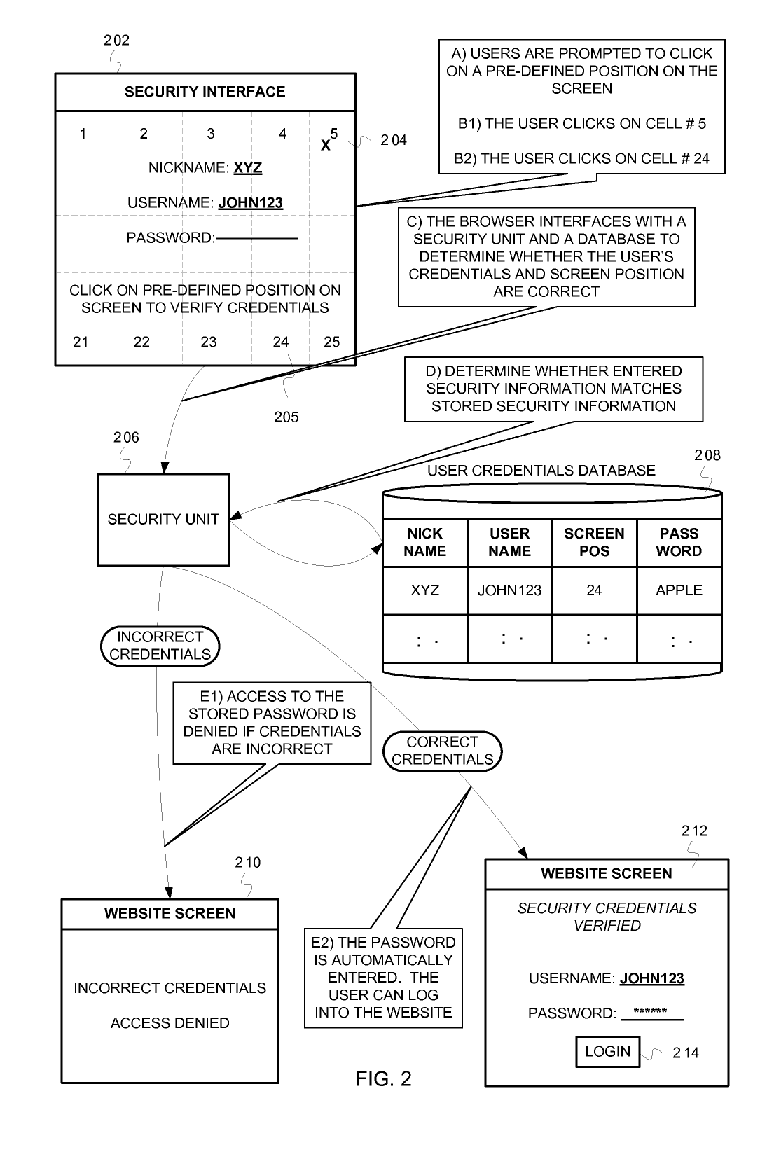

FIG. 2 is an example conceptual diagram of protecting login credentials with positional security information. FIG. 2 depicts a security interface 202, a security unit 206, and a user credentials database 208. When a user launches a browser instance and requests access to a website, the browser instance determines whether the user has previously stored login credentials associated with the requested website. If the browser instance determines that there exist stored login credentials for the requested website, the browser instance tries to retrieve and automatically enter the user's stored login credentials. The security unit 206 monitors the operations of the browser instance and detects that the browser instance intends to automatically provide the stored login credentials. The security unit 206 then presents a security interface 202 on the browser instance to ensure that the user trying to log in is authorized to use the stored login credentials.

At stage A, the security unit 206 prompts the user, via the security interface 202, to enter a username and click on a position on the security interface 202 to enable user authentication. The user may also be prompted to enter a nickname, an identification number, biometric data, etc., as an alternative to entering the username or as an additional security measure. The additional security measures may be implemented to enhance security of website access.

At stage B1, the user clicks on cell 5 (204).

At stage C, the browser instance captures the entered data (i.e., the nickname and/or the username, and positional information) and interfaces with the security unit 206 to determine whether the entered data is accurate. At stage D, the security unit 206 accesses the user credentials database 208 and compares the entered information with the information stored in an appropriate entry of the user credentials database 208. At stage E1, the security unit 206 determines that the entered information is incorrect. The user clicked on cell 5 (204) while the stored screen position is 24 (refer to the user credentials database 208). The security unit 206 blocks the browser instance's access to the user credentials database 208. The browser instance is prevented from accessing and providing the stored password (or other stored credentials) as depicted on a screen 210 displayed by the web browser. The security interface 202 may be presented. In some implementations, the security unit 206 may allow the user a preconfigured (or user defined) number of incorrect login attempts. The security unit 206 may block access to the website if the user exceeds the number of allowable consecutive incorrect login attempts.

Alternately, at stage B2, the user enters the correct information and clicks on cell 24 (205). Therefore, at stage E2, the security unit 206 determines that the entered information is correct. The security unit 206 accesses and provides the user's password on the login screen. In some implementations, the security unit 206 can direct the browser instance to access and enter the user's password or other stored login credentials as depicted on a screen 212 displayed by the web browser. The user can click on a “login” button 214 on the screen 212 to proceed within the website or can automatically login using the accessed stored login credentials.

The conceptual block diagrams depicted in FIGS. 1-2 should not be used to limit embodiments as the functionality described with reference to FIGS. 1-2 may be performed by blocks not shown in the figures. For example, although the security unit is depicted as an independent unit running on a computer system and separate from the browser instance, the security unit may be a hardware or software module integrated with the browser instance. As another example, in some implementations, the browser instance may trigger the security unit when users indicate that their login information should be stored. Also, although FIGS. 1-2 illustrate operations for web browsers, the operations may be extended to any resources, which require a user to enter login credentials to access the resources. For example, resources can comprise web applications (e.g., websites), local applications that do not require the use of the Internet (e.g., word processing applications), chat applications, etc. Furthermore, embodiments can use positional security information to locally verify the user before transmitting login credentials to a server for website access. This can prevent unauthorized users with stolen login credentials from gaining access to a website.

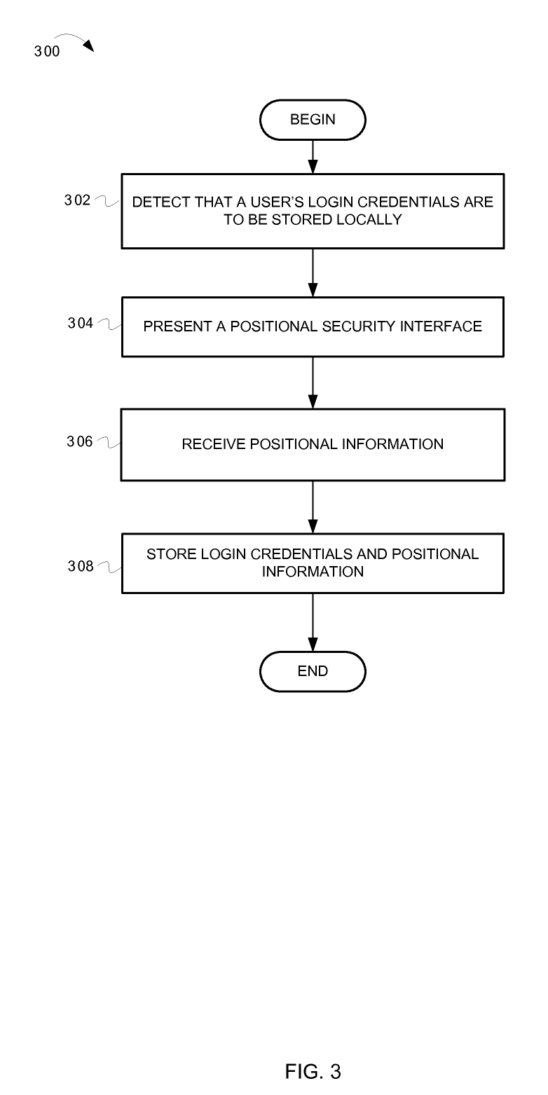

FIG. 3 is a flow diagram illustrating example operations for configuring positional security to protect stored login information. The flow 300 begins at block 302.

At block 302, it is detected that a user's login credentials are to be stored locally. The user may want to store login credentials (e.g., username, password, etc.) for easy access or to avoid having to enter the login credentials. The flow continues at block 304.

At block 304, a positional security interface is presented. The positional security interface may be presented in the form of a grid screen with a pre-defined number of cells in the grid. The number of cells in the grid may be related to the desired security level. For example, the grid may comprise a large number of small cells to achieve a high security level, while the grid may comprise a small number of large cells to achieve a low security level. In other implementations, the positional security interface may comprise a series of graphical objects (e.g., links, buttons, radio buttons, check boxes, graphical shapes, etc). The user may be prompted to click on a cell in the grid (or on one of the graphical objects) and configure positional security information. The user may also be prompted to click on a series of graphical objects or connect a series of dots to configure positional security information. In some implementations, the positional security interface may be in the form of a pre-defined image (e.g., an image uploaded by the user). The user may be prompted to click on a pre-defined position in a grid on the image to configure positional information. In some implementations, the user may also be prompted to enter additional security information in the form of a nickname, user identification number, biometric data (e.g., fingerprints, etc.). Any one or more of the additional security information may be used in conjunction with the positional information to verify the authenticity of the user. The flow continues at block 306.

At block 306, the positional information is received. When the user clicks on the positional interface, the location of the mouse pointer may be determined to establish the positional information. In some implementations, the graphical objects or cells in the grid on the positional interface may be identified by numbering the cells row-wise, numbering the cells column-wise, associating a row number and a column number with the cells, or associating a range of pixels with the cells. The positional information may be stored as a number representing the clicked position on the positional interface. In implementations where the positional interface is displayed on a touch screen, the positional information may be determined by determining the position on the screen touched by the user. In another implementation, the position indicated by touching a stylus to a display may also be used to determine positional information. The flow continues at block 308.

At block 308, the login credentials and the positional information are stored. Additional security information (e.g., nickname, biometric data), if entered, is also stored. The additional security information may be used separately or in conjunction with the positional information to verify the authenticity of the user trying to access the login credentials. From block 308, the flow ends.

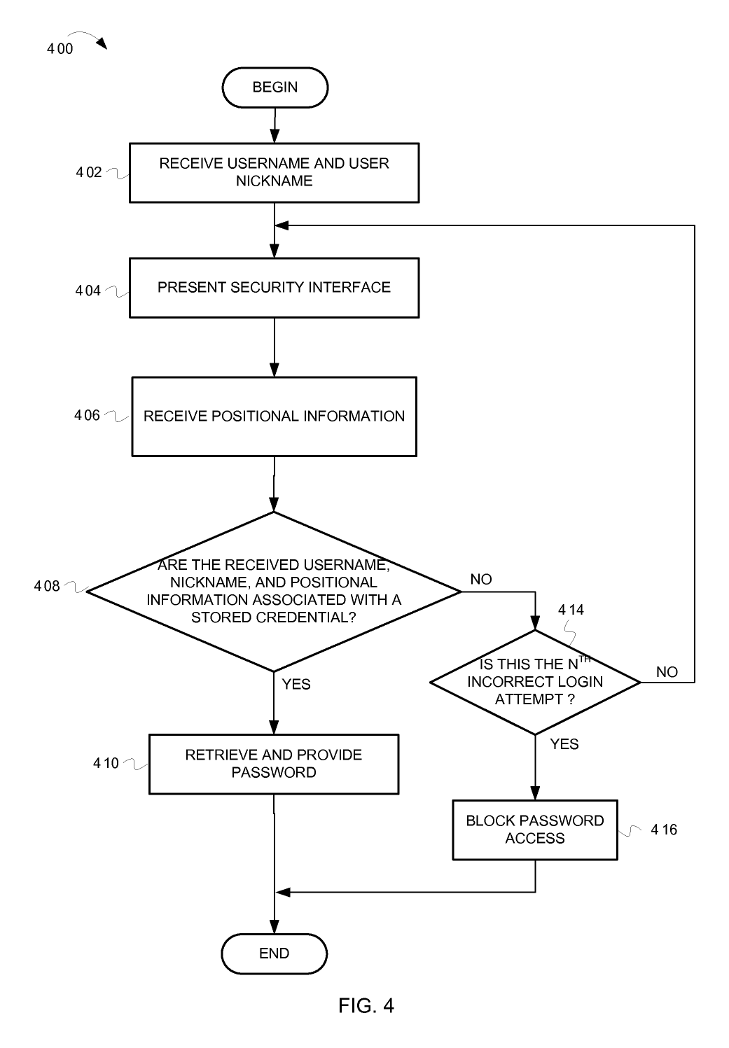

FIG. 4 is a flow diagram illustrating example operations for implementing positional security for local authentication. The flow 400 begins at block 402.

At block 402, a user nickname and/or a username are received. In some implementations, the user may select a user name from a drop down menu. In other implementations, the username may be automatically entered as soon as the webpage is loaded. In other implementations, the username may be automatically entered after the user types in a pre-defined number of username characters. The received user nickname may be used separately or in conjunction with the username to locally authenticate the user. The flow continues at block 404.

At block 404, a positional security interface is presented. In some implementations, the positional security interface may be presented in response to a detected browser instance trying to automatically enter user credentials. The positional security interface may comprise of a grid with multiple cells or a series of graphical objects (e.g., links, buttons, checkboxes, etc.) on the interface. The user may be prompted, via the positional security interface, to enter positional information by clicking on one of the cells or other graphical objects. Additional security may be provided, e.g., in the form of a user nickname, to ensure that the user trying to access the stored login credentials is an authorized user. The flow continues at block 406.

At block 406, positional information is received. When the user clicks on the positional security interface, the location of the mouse pointer may be determined to establish the positional information. The positional information is stored as a number representing the position of the clicked object on the positional interface. The positional information may also be represented as a set of screen co-ordinates. The flow continues at block 408.

At block 408, it is determined whether the received username, nickname, and positional information are associated with a stored credential. Positional information corresponding to the received username and/or the received nickname may be retrieved from a database (“retrieved positional information”). The received credentials and thus the user may be validated by comparing the received positional information with the retrieved positional information. In some embodiments, other received security information (e.g., biometric information) and/or received login credentials (e.g., user identification number) may be compared to the corresponding stored security and login credentials. The user may configure the stored security information when a security application or a browser with an underlying security feature is installed. The user may configure the stored information by defining a nickname and selecting positional information associated with the login credentials (e.g., login username and password). Granting access to the website only if there is a match between the received and the stored login credentials and security information can prevent unauthorized use of login credentials. If it is determined that the received information corresponds with the stored information, the flow continues at block 410. Otherwise, the flow continues at block 414.

At block 410, the password associated with the username is retrieved and provided to the browser instance. The browser instance may also present a “login” button allowing the users to log into the website. From block 410, the flow ends.

At block 414, it is determined whether the user has attempted N consecutive incorrect login attempts. The number of allowable incorrect login attempts (N) may be determined during the security feature's configuration stage. If it is determined that the user has exceeded the maximum number of consecutive failed login attempts, the flow continues at block 416. Otherwise, the flow continues at block 404, where the positional security interface is presented.

At block 416, the browser instance is prevented from accessing and providing the password associated with the username. In some implementations, browser access to the password may be locked and may require an administrator's authorization. From block 416, the flow ends.

It should be understood that the depicted flow diagrams (FIGS. 3-4) are examples meant to aid in understanding embodiments and should not be used to limit embodiments or limit scope of the claims. Embodiments may perform additional operations, fewer operations, operations in a different order, operations in parallel, and some operations differently. For example, in some implementations, a password may also be received at block 402 and positional information may be used to locally verify the user. Also, in some implementations, a user nickname may not be received at block 402 and only positional information may be used to authenticate the user. In other implementations, positional information may be used in place of a password. The positional information may not be verified locally but may be sent to a server (along with a username or other login credentials) for website access. Also, it should be noted that the operations described in FIGS. 3-4 might be extended to any resources (e.g., websites, applications, etc.) that require a user to enter login credentials to access the resources.

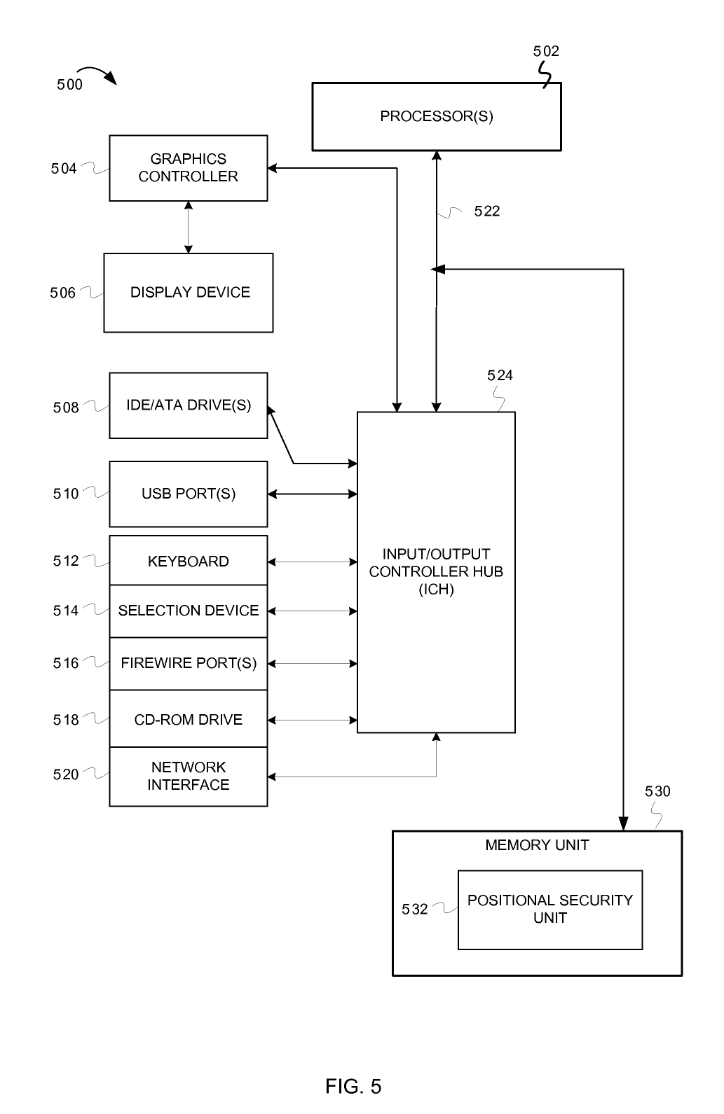

FIG. 5 is an example computer system for configuring and implementing positional security to protect stored user credentials. The computer system 500 includes a processor 502. The processor 502 is connected to an input/output controller hub 524 (ICH), also known as a south bridge, via a bus 522 (e.g., PCI, ISA, PCI-Express, HyperTransport, etc). A memory unit 530 interfaces with the processor 502 and the ICH 524. The main memory unit 530 can include any suitable random access memory (RAM), such as static RAM, dynamic RAM, synchronous dynamic RAM, extended data output RAM, etc.

The memory unit 530 embodies functionality to use positional information to locally verify the authenticity of a user trying to access stored credentials. The memory unit 530 comprises a positional security unit 532. The positional security unit 532 implements functionality to control access to locally stored login credentials based, at least in part, on positional security information. The positional security unit 532 can also implement functionality to authorize transmission of the locally stored credentials based, at least in part, on the positional security information. Embodiments are not limited to implementing these functionalities in the positional security unit 532 embodied in the memory unit 530. Some or all of these functionalities can be embodied in software, hardware, or a combination of hardware and software. For example, the functionalities implemented by the positional security unit 532 can be embodied in the processor 502, a security card (not shown), etc.

The ICH 524 connects and controls peripheral devices. In FIG. 5, the ICH 524 is connected to IDE/ATA drives 508 (used to connect external storage devices) and to universal serial bus (USB) ports 510. The ICH 524 may also be connected to a keyboard 512, a selection device 514, firewire ports 516 (for use with video equipment), CD-ROM drive 518, and a network interface 520. The ICH 524 can also be connected to a graphics controller 504. The graphics controller is connected to a display device (e.g., monitor). In some embodiments, the computer system 500 can include additional devices and/or more than one of each component shown in FIG. 5 (e.g., video cards, audio cards, peripheral devices, etc.). For example, in some instances, the computer system 500 may include multiple processors, multiple cores, multiple external CPU's. In other instances, components may be integrated or subdivided.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system”. Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

While the embodiments are described with reference to various implementations and exploitations, it will be understood that these embodiments are illustrative and that the scope of the inventive subject matter is not limited to them. In general, techniques for positional password confirmation as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
a device presenting a positional security interface that indicates a plurality of selectable positions that govern automatic use of at least one locally stored login credential;
detecting an indication of at least a first of the plurality of selectable positions on the positional security interface;
accessing storage to determine if the first of the plurality of selectable positions is associated with the at least one locally stored login credential;
determining that the first of the plurality of selectable positions is associated with the at least one locally stored login credential; and
authorizing automatic use of the locally stored login credential for accessing a corresponding resource provided by a server based, at least in part, on said determining that the first of the plurality of selectable positions is associated with the at least one locally stored login credential.

2. The method of claim 1, wherein said presenting the positional security interface is in response to one or more of detecting automatic completion of a username, detecting a browser instance requesting access to the at least one locally stored login credential, receiving a request for the at least one locally stored login credential, and detecting access of a website login page.

3. The method of claim 1, wherein the at least one locally stored login credential comprises one or more of a username, a user identification number, a nickname, a password, and biometric information.

4. The method of claim 1, further comprising:
the device presenting the positional security interface that indicates the plurality of selectable positions that govern automatic use of at least one locally stored login credential;
detecting a second indication of at least a second of the plurality of selectable positions on the positional security interface;
accessing the storage to determine if the second of the plurality of selectable positions is associated with the at least one locally stored login credential;
determining that the second of the plurality of selectable positions is not associated with the at least one locally stored login credential; and
blocking automatic use of the locally stored login credential for accessing a corresponding resource provided by the server based, at least in part, on said determining that the second of the plurality of selectable positions is associated with the at least one locally stored login credential.

5. The method of claim 1, further comprising:
the device presenting the positional security interface that indicates the plurality of selectable positions that govern automatic use of at least one locally stored login credential;
detecting a second indication of at least a second of the plurality of selectable positions on the positional security interface; and
transmitting to the server, associated with a corresponding resource, the second of the plurality of selectable positions and the least one locally stored login credential.

6. The method of claim 1, further comprising receiving a nickname input that corresponds to the first selectable position, accessing the storage to determine if the input nickname is associated with the locally stored login credential and the first selectable position, wherein said authorizing automatic use of the locally stored login credential for accessing the corresponding resource provided by the server is also based on said determining that the input nickname is associated with both the locally stored login credential and the first selectable position.

7. The method of claim 1, wherein the plurality of selectable positions on the positional security interface comprises any one of a plurality of cells that correspond to a grid on the positional security interface, a plurality of buttons on the positional security interface, a plurality of checkboxes on the positional security interface, and a plurality of graphical objects on the positional security interface.

8. The method of claim 1, wherein the plurality of selectable positions on the positional security interface are identified by any one of numbering the cells row-wise, numbering the cells column-wise, associating a row number and a column number with the cells, and associating a range of pixels with the cells.

9. The method of claim 1, wherein the detecting an indication of at least the first of the plurality of selectable positions on the positional security interface comprises one or more of selecting one of the plurality of selectable positions on the positional interface and selecting a combination of selectable positions on the positional interface.

10. The method of claim 1 further comprising:
detecting a second indication that at least one login credential is to be stored locally;
presenting the positional security interface that indicates the plurality of selectable positions that govern automatic use of the at least one login credential to be locally stored;
detecting a second indication of at least a second of the plurality of selectable positions on the positional security interface;
storing the at least one login credential and the second of the plurality of selectable positions.

11. A computer program product for positional password confirmation, the computer program product comprising:
a computer usable medium having computer usable program code embodied therewith, the computer usable program code comprising:
computer usable program code configured to:
present a positional security interface that indicates a plurality of selectable positions that govern automatic use of at least one locally stored login credential;
detect an indication of at least a first of the plurality of selectable positions on the positional security interface;
determine if the first of the plurality of selectable positions is associated with the at least one locally stored login credential;
determine that the first of the plurality of selectable positions is associated with the at least one locally stored login credential; and
authorize automatic use of the locally stored login credential for accessing a corresponding resource based, at least in part, on said computer usable program code determining that the first of the plurality of selectable positions is associated with the at least one locally stored login credential.

12. The computer program product of claim 11, wherein said computer usable program code being configured to present the positional security interface is in response to one or more of the computer usable program code detecting automatic completion of a username, the computer usable program code detecting a browser instance requesting access to the at least one locally stored login credential, the computer usable program code receiving a request for the at least one locally stored login credential, and the computer usable program code detecting access of a website login page.

13. The computer program product of claim 11, wherein the at least one locally stored login credential comprises one or more of a username, a user identification number, a nickname, a password, and biometric information.

14. The computer program product of claim 11, wherein the computer usable program code is further configured to:
present the positional security interface that indicates the plurality of selectable positions that govern automatic use of at least one locally stored login credential;
detect a second indication of at least a second of the plurality of selectable positions on the positional security interface;
determine if the second of the plurality of selectable positions is associated with the at least one locally stored login credential;
determine that the second of the plurality of selectable positions is not associated with the at least one locally stored login credential; and
block automatic use of the locally stored login credential for accessing a corresponding resource based, at least in part, on said computer usable program code determining that the second of the plurality of selectable positions is associated with the at least one locally stored login credential.

15. The computer program product of claim 11, wherein the computer usable program code is further configured to:
present the positional security interface that indicates the plurality of selectable positions that govern automatic use of at least one locally stored login credential;
detect a second indication of at least a second of the plurality of selectable positions on the positional security interface; and
transmit to a server, associated with a corresponding resource, the second of the plurality of selectable positions and the least one locally stored login credential.

16. The computer program product of claim 11, wherein the computer usable program code is further configured to receive a nickname input that corresponds to the first selectable position, access the storage to determine if the input nickname is associated with the locally stored login credential and the first selectable position, wherein said computer usable program code being configured to authorize automatic use of the locally stored login credential for accessing the corresponding resource is also based on said computer usable program code determining that the input nickname is associated with both the locally stored login credential and he first selectable position.

17. The computer program product of claim 11, wherein the plurality of selectable positions on the positional security interface are identified by any one of numbering the cells row-wise, numbering the cells column-wise, associating a row number and a column number with the cells, and associating a range of pixels with the cells.

18. An apparatus comprising:
a processor;
a network interface coupled with the processor;
a security unit configured to
present a positional security interface that indicates a plurality of selectable positions that govern automatic use of at least one locally stored login credential;
detect an indication of at least a first of the plurality of selectable positions on the positional security interface;
determine if the first of the plurality of selectable positions is associated with the at least one locally stored login credential;
determine that the first of the plurality of selectable positions is associated with the at least one locally stored login credential; and
authorize automatic use of the locally stored login credential for accessing a corresponding resource based, at least in part, on said determining that the first of the plurality of selectable positions is associated with the at least one locally stored login credential.

19. The apparatus of claim 18, wherein the security unit is configured to present the positional security interface in response to one or more of detecting automatic completion of a username, detecting a browser instance requesting access to the at least one locally stored login credential, receiving a request for the at least one locally stored login credential, and detecting access of a website login page.

20. The apparatus of claim 18, wherein the security unit comprises one or more machine-readable media.
